(19) United States
(12) Patent Application Publication
(10) Pub. No.: US 2015/0020570 A1
(43) Pub. Date: Jan. 22, 2015

(54) DEVICE FOR DETERMINING A GAS MASS FLOW RATE, AND METHOD FOR RE-CALIBRATING SUCH A DEVICE

(71) Applicant: PIERBURG GMBH, NEUSS (DE)

(72) Inventors: Karl Wuebbeke, Inden (DE); Lars Baumeister, Nettetal (DE); Dirk Kamarys, Willich-Neersen (DE); Manfred Schrammek, Moembris (DE)

(73) Assignee: PIERBURG GMBH, NEUSS (DE)

(21) Appl. No.: 14/384,689

(22) PCT Filed: Jan. 22, 2013
(86) PCT No.: PCT/EP2013/051086

§ 371 Date: Sep. 12, 2014

(30) Foreign Application Priority Data
Mar. 13, 2012 (DE) 10 2012 102 094.9

(51) Int. Cl. G01F 25/00; G01F 1/68

(52) U.S. Cl. CPC G01F 25/00; G01F 1/68
USPC 73/1.16

(57) ABSTRACT

A device for determining a gas mass flow rate includes a first sensor unit comprising at least one first temperature measuring element and a first heating element. A second senor unit comprises at least one second temperature measuring element and a second heating element. A control unit is configured to adjust the first heating element to a first controlled excessive temperature. The control unit is connected to the second heating element so that the second heating element is adjustable to a second controlled excessive temperature.

### CROSS REFERENCE TO PRIOR APPLICATIONS

This application is a U.S. National Phase application under 35 U.S.C. §371 of International Application No. PCT/EP2013/051086, filed on Jan. 22, 2013 and which claims benefit to German Patent Application No. 10 2012 102 094.9, filed on Mar. 13, 2012. The International Application was published in German on Sep. 19, 2013 as WO 2013/135405 A1 under PCT Article 21(2).

### FIELD

The present invention relates to a device for determining a gas mass flow rate with a first sensor unit comprising at least a first temperature measuring element and a first heating element, a second sensor unit comprising a second temperature measuring element and a second heating element, and a control unit by which the at least one temperature measuring element can be adjusted to controlled excessive temperatures, as well as to a method for re-calibrating a device for determining a gas mass flow rate, wherein the first heating element of the first sensor unit is adjusted to a first controlled excessive temperature and whereupon a mass flow rate is calculated from the heat dissipation of the at least one heating element of the first sensor unit in dependence on the temperature of the temperature measuring element.

### BACKGROUND

Devices for measuring gas mass flow rates are primarily known from the field of intake air mass measurement in internal combustion engines. Particularly good results are achieved with air mass measuring devices that operate according to the principle of hot-film anemometry. A heating element of the sensor is thereby heated, wherein the heat generated by the heating element is transmitted to the flowing medium by convection. The temperature change resulting therefrom, or the additional power input for maintaining the heating element temperature, represent a measure for the existing mass flow.

Modified mass flow sensors have also been used in recent years to measure the exhaust gas mass flow rate, as described, for example, in DE 10 2006 058 425 A1. This device for determining the mass flow rate has two sensor units separate from each other, a first sensor unit to calculate the mass flow rate by determining a power loss, and a second sensor unit to determine the temperature of the exhaust gas flow. The heating element of the first sensor unit is either adjusted to an excessive temperature that differs constantly from the temperature measuring element, or it is adjusted to a controlled excessive temperature. It is possible to drawn conclusions on the exhaust gas mass flow rate from the additional power input required therefor. Contaminations that would compromise the measuring result must, however, be avoided, which is why the temperature measuring element also comprises a heating element by means of which it is possible to burn off in particular soot deposits on the substrate. In addition to the problem of contamination occurring when used in the exhaust gas system, there also exists the problem of obtaining representative measuring results while pulsations and turbulences occur, as they frequently do in the exhaust gas system. DE 10 2006 058 425 A1 therefore describes arranging two temperature measuring elements one behind the other thereby making it possible to detect a direction by means of the given heat transfer from the respective upstream portion to the downstream portion, which can be included in the calculation of the exhaust gas mass flow rate.

Despite these possibilities of detecting direction or position and of burning off deposits, after longer periods of operation, however, measuring value deviations are caused by external influences on the sensor, e.g., by the formation of deposits.

### SUMMARY

An aspect of the present invention is to provide a device for determining a gas mass flow rate, as well as a method for the re-calibration of such a device, which provides an exhaust gas flow rate measurement with minimized measuring value deviations.

In an embodiment, the present invention provides a device for determining a gas mass flow rate which includes a first sensor unit comprising at least one first temperature measuring element and a first heating element. A second senor unit comprises at least one second temperature measuring element and a second heating element. A control unit is configured to adjust the first heating element to a first controlled excessive temperature. The control unit is connected to the second heating element so that the second heating element is adjustable to a second controlled excessive temperature.

In an embodiment, the present invention also provides a method for recalibrating the above device for determining a gas mass flow rate which includes adjusting the first heating element to a first controlled excessive temperature. A first mass flow rate is calculated from a heat dissipation of the first heating element in dependence on a temperature of the at least one second temperature measuring element. The first mass flow rate determined is stored if a controlled stationary engine condition is detected. The control unit is switched over. The second heating element is adjusted to a second controlled excessive temperature. A second mass flow rate is calculated from a heat dissipation of the second heating element in dependence on a temperature of the at least one first temperature measuring element. The first mass flow rate is compared with the second mass flow rate. The first sensor unit is recalibrated based on a correction table stored in the control unit.

### BRIEF DESCRIPTION OF THE DRAWINGS

The present invention is described in greater detail below on the basis of embodiments and of the drawings in which:

FIG. 1 shows a schematical side elevational view of a device for determining a mass flow rate in a duct according to the present invention;

FIG. 2 shows a schematic top plan view on the first sensor unit of the device for determining a mass flow rate; and

FIG. 3 shows a schematic top plan view on the second sensor unit of the device for determining a mass flow rate.

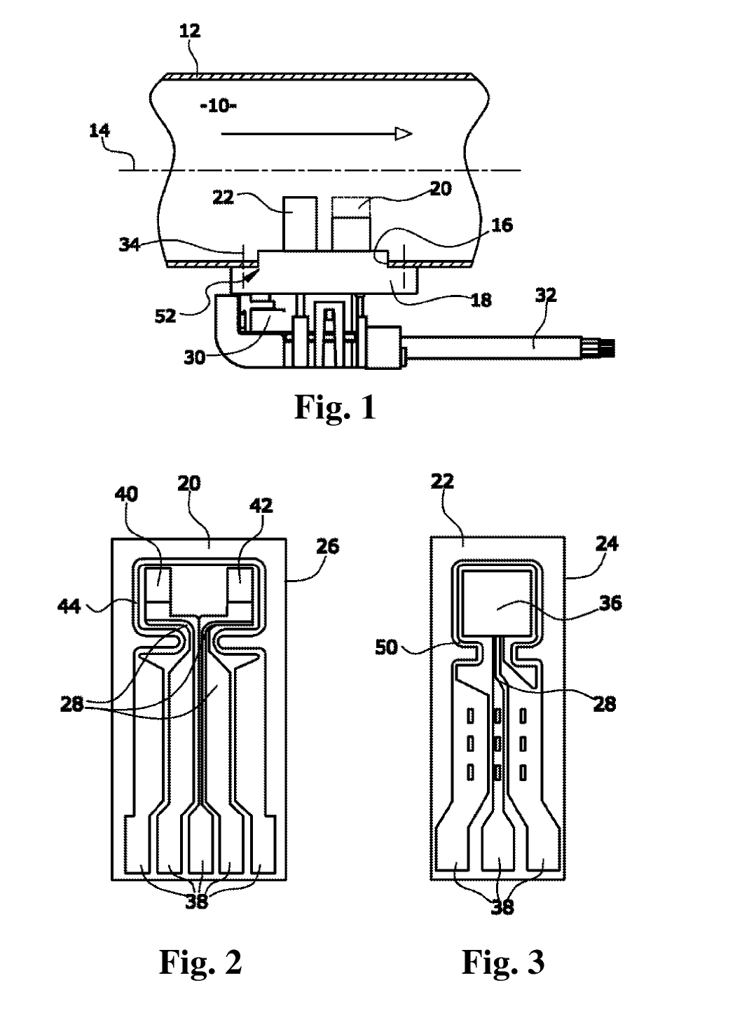

### DETAILED DESCRIPTION

It is possible to invert the function of the two sensor units because the control unit is connected to the heating element of the second sensor unit so that the heating element can also be adjusted to a controlled excessive temperature. When a controlled stationary engine condition is detected, the gas mass flow rate determined is therefore stored, whereupon the control unit switches over and the heating element of the second sensor unit is adjusted to a controlled excessive temperature, and a mass flow rate is calculated from the heat dissipation of the at least one heating element of the second sensor unit dependent on the temperature of the temperature measuring element of the first sensor unit, both values of the gas mass flow rate are compared with each other, and the first sensor unit is re-calibrated according to a correction table stored in the control unit. Deposits changing the measuring value do not exist in the inverted measurement. The result of the inverted measurement will therefore largely be free from errors since the second sensor unit is not heated in operation. With the characteristic map correctly determined in advance and with the stationary engine condition known, it is possible to determine a correct reference value, with which the first sensor unit for determining correct exhaust gas mass flow rates can be re-calibrated during operation.

In an embodiment of the device of the present invention, the heating elements can, for example, be arranged on the substrates in a meander or an omega shape. A uniform constant temperature distribution can thereby be achieved on the substrate, whereby measuring errors between the determined values of the measuring elements on a substrate, which are caused by an inhomogeneous temperature distribution, are avoided.

In an embodiment of the device of the present invention, the first sensor unit can, for example, comprise two temperature measuring elements connected to the control unit. The difference in the measured temperatures of the two temperature measuring elements on the first sensor unit is then used to detect the flow direction. Such an arrangement and the method described allow pulsations to be detected and thus transient flow inversions that can be properly considered in the calculation. In this regard, use is made of the fact of the existence of a heat emission to the respective downstream temperature measuring element.

In an embodiment of the device of present invention, the second sensor unit can, for example, have two temperature measuring elements which are connected to the control unit. It is thereby possible to also consider pulsations during re-calibration and to determine errors by the individual measuring elements by comparing the two measured temperatures.

In an embodiment of the method of the present invention, the control unit can, for example, again switch over in a subsequent step so that the heating element of the first sensor unit is adjusted to the controlled excessive temperature. The normal operational state is thus automatically restored after re-calibration.

In order to avoid errors in re-calibrating, the second sensor unit is burnt clean by means of the second heating element before re-calibration so that the actual measuring values of the sensor units form the basis of re-calibration.

A device for determining a gas mass flow rate and a method for re-calibrating such a device are therefore provided which can, for the entire service life of the sensor, correctly calculate the exhaust gas mass flow rate independently of the deposits occurring by performing an inversion of the sensor unit function and a constantly repeated calibration of the first sensor unit.

An embodiment of the present device for determining a mass flow rate is illustrated in the drawings and will be described hereinafter, as will be the present method for re-calibration.

The present device for determining a mass flow rate is arranged in a duct 10 through which exhaust gas flows and which is delimited by walls 12. An opening 16 is formed in the wall 12, which opening 16 extends vertically relative to a duct axis 14 and through which a housing 18 of a device for determining an exhaust gas mass flow rate extends into the duct 10.

From the housing 18, a first sensor unit 20 and a second sensor unit 22 extend into the duct 10, which are formed by mostly multi-layered ceramic substrates 24, 26 on which platinum thin-film resistors and conductor paths 28 are arranged in a manner known per se.

The sensor units 20, 22 are typically arranged in parallel one behind the other as seen in the main flow direction of the exhaust gas, wherein the main direction of extension of each of sensor units 20, 22 is also parallel to the main flow direction in the duct 10. Owing to the parallelism of the connecting line of the sensor units 20, 22 with respect to the main flow direction of the exhaust gas, there is no frontal flow against the sensors but the flow merely passes over them, whereby deposits on the support body are significantly reduced.

In a manner known per se, the device operates according to hot-film anemometry and comprises, besides the two sensor units 20, 22, a plug element 30 at the end of the housing 18 opposite the sensor units 20, 22, via which plug element 30 the sensor units 20, 22 are connected to a control unit 52 through a connecting wire 32, which control unit 52 is only illustrated schematically and may alternatively be arranged either in the housing 18 or in the motor control unit. The connecting wire 32 correspondingly serves for voltage supply and data transmission. The housing 18 is fastened by a flange connection 34.

The upstream second sensor unit 22 forms a temperature sensor with which the respective exhaust gas temperature is measured. This is done through a temperature measuring element 36 which may be formed, for example, by two platinum thin-film resistors of different resistance values. The temperature measuring element 36 is electrically connected to the control unit 52 through the conductor paths 28 and contact tabs 38. In normal operation, this sensor unit 22 serves to measure the temperature of the gas flow to be measured. A heating element 50 is further arranged on the substrate 24, which heating element 50 is shaped like an omega in order to achieve a uniform temperature distribution on the substrate 24.

In the present embodiment, the downstream first sensor unit 20 comprises two temperature measuring elements 40, 42 on the substrate 26, which are both independently connected to the control unit 52 through conductor paths 28 and contact tabs 38. In operation, a heating element 44 is either heated to a constant excessive temperature or it is heated to a constant temperature difference to the temperature measuring element 36 of the second sensor unit. The heating element 44 is cooled by the existing flow so that the element requires a continuous power input in order to maintain the controlled excessive temperature. In the control unit 52, this power input or the heat dissipation can be converted by means of a stored characteristic map into an exhaust gas mass flow rate in dependence on the existing exhaust gas temperature measured by the sensor unit 22. In order to exclude an influence on the temperature sensor, i.e., on the second sensor unit 22, by the first sensor unit 20 being heated through heat transfer towards the main exhaust gas flow, the first sensor unit 20 is arranged downstream relative to the second sensor unit 22.

The use of two temperature measuring elements 40, 42 on the substrate 26 serves to determine and consider occurring exhaust gas pulsations, i.e., a temporary inversion of the exhaust gas flow direction, as it may be expected in the exhaust gas portion of a reciprocating piston engine due to the intake and expulsion movements. It is here assumed that the respective downstream temperature measuring element 42 measures a higher temperature than the upstream temperature measuring element 40 since the heat transfer from the upstream temperature measuring element 40 is transported towards the downstream temperature measuring element 42 by the exhaust gas flow. Correspondingly, upon flow inversion, heat is transported in the opposite direction so that it is either assumed that the respective upstream temperature measuring element 40 is representative of the exhaust gas flow flowing in the corresponding direction or a characteristic map is stored in which an exhaust gas mass flow rate of both available power inputs is stored for different flow conditions and power inputs of the two temperature measuring elements 40, 42.

The heating element 44 of the first sensor unit 20 is also omega-shaped in order to allow a uniform heating of the substrate 26.

Despite the possibility of burning the surfaces of the sensor units 20, 22 clean, in particular of burning off soot, errors are, however, created in measurement as the number of operating hours increases. These errors are due to deposits on the first sensor unit 20 which are formed from chemical impurities in the exhaust gas under the constant thermal stress that cannot be avoided due to the heating of the first sensor element 20 for the purpose of reaching the excessive temperature. Almost undetachable layers of deposit are formed from different compositions which interfere with the normal measuring operation. When the temperature sensor is not operated at an increased temperature, these deposits do not exist.

According to the present invention, the second sensor unit 22, and in particular the heating element 40, is therefore connected to the control unit 52 so that this second sensor unit 22 can be controlled in the same manner as the first sensor unit 20. This means that in a stationary engine load state, the functions of the two sensor units 20, 22 are switched and that in this case the heating element 50 is heated to an excessive temperature increased with respect to the temperature of the exhaust gas flow. The additional power input required for maintaining the excessive temperature is again a measure of the existing exhaust gas mass flow rate.

The value thus determined for the exhaust gas mass flow rate is compared to the value for the exhaust gas mass flow rate determined by the second sensor unit 20, and a re-calibration of the first sensor unit 20 is performed corresponding to the deviation using a characteristic map or a correction table stored in the control unit 52.

The correction table is determined beforehand by trials using known operating conditions with the functioning of the two sensor units 20, 22 being inverted.

Before this routine for re-calibration is carried out, both of the heating elements 44, 50 of the sensor units 20, 22 should be heated up to burn the surfaces clean so as to avoid measuring errors caused by soot deposits.

The re-calibrations performed should be stored for later diagnoses.

Using the device described and the method described, it is possible, even if non-burnable deposits exist on the surface of a sensor unit, to still obtain correct measuring results regarding the exhaust gas mass flow rate over a long operating period, which results are necessary for an optimal motor control in the interest of reducing harmful emissions and of reducing consumption.

It should be clear that the scope of protection of the main claim is not restricted to the embodiment described and that reference should be had to the appended claims. The function of the control unit may of course also be fulfilled by the engine control. Two sensor units of identical structure can moreover be used so that, during re-calibration, the flow direction can also be considered by measuring the power loss at the second sensor unit. A version is further conceivable which comprises only one measuring element or temperature measuring element on a respective sensor.

What is claimed is:

1-8. (canceled)

9. A device for determining a gas mass flow rate, the device comprising:
a first sensor unit comprising at least one first temperature measuring element and a first heating element;
a second senor unit comprising at least one second temperature measuring element and a second heating element; and
a control unit configured to adjust the first heating element to a first controlled excessive temperature, the control unit being connected to the second heating element so that the second heating element is adjustable to a second controlled excessive temperature.

10. The device as recited in claim 9, wherein the first sensor unit further comprises a first substrate, and the second sensor unit further comprises a second substrate, wherein the first heating element is arranged on the first substrate in a shape of a meander or an omega, and the second heating element is arranged on the second substrate in a shape of a meander or an omega.

11. The device as recited in claim 9, wherein the at least one first temperature measuring element comprises two temperature measuring elements each of which are connected to the control unit.

12. The device as recited in claim 9, wherein t least one second temperature measuring element further comprises two temperature measuring elements each of which are connected to the control unit.

13. A method for recalibrating a device for determining a gas mass flow rate, the device comprising:
a first sensor unit comprising at least one first temperature measuring element and a first heating element;
a second senor unit comprising at least one second temperature measuring element and a second heating element; and
a control unit comprising a stored correcting table
the method comprising:
adjusting the first heating element to a first controlled excessive temperature;
calculating a first mass flow rate from a heat dissipation of the first heating element in dependence on a temperature of the at least one second temperature measuring element;
storing the first mass flow rate determined if a controlled stationary engine condition is detected;
switching over the control unit;
adjusting the second heating element to a second controlled excessive temperature;
calculating a second mass flow rate from a heat dissipation of the second heating element in dependence on a temperature of the at least one first temperature measuring element;
comparing the first mass flow rate with the second mass flow rate; and
recalibrating the first sensor unit based on the correction table.

14. The method as recited in claim 13, further comprising:
switching over the control unit so that the first heating element is adjusted to a third controlled excessive temperature.

15. The method as recited in claim 13, wherein, the at least one first temperature measuring element comprises two temperature measuring elements, and the method further comprises determining a flow direction using a difference in a power input or in an excessive temperature between the two temperature measuring elements.

16. The method as recited in claim 13, wherein, prior to the recalibration, the method further comprises burning the second sensor unit clean with the second heating element.
